(19) United States
(12) Patent Application Publication
(10) Pub. No.: US 2026/0056591 A1
(43) Pub. Date: Feb. 26, 2026

(54) INTERRUPTING A NETWORK POWER-DOWN SEQUENCE IN A PROCESSOR-BASED SYSTEM TO SERVICE A CLIENT REQUEST

(71) Applicant: QUALCOMM Incorporated, San Diego, CA (US)

(72) Inventors: Utkarsh Vinayak, Patna (IN); Khirod Kumar Nayak, Koraput (IN); Sharath Kumar Nagilla, Hyderabad (IN); Mohd Salman, Kiratpur (IN); Shaunish Goel, Hyderabad (IN)

(21) Appl. No.: 18/809,879

(22) Filed: Aug. 20, 2024

(51) Int. Cl. G06F 1/3209

(52) U.S. Cl. CPC G06F 1/3209

(57) ABSTRACT

A processing system includes a client network circuit over which a processing circuit communicates with one or more client circuits to carry out tasks of a software application executing in the processing circuit. During a period of inactivity in the client circuit(s), the client network circuit may enter a low-power mode by initiating a power-down sequence. The exemplary client network circuit includes a monitor circuit to receive client requests from the client circuit(s) in case the client circuit becomes active during the power-down sequence. The monitor circuit provides an interrupt signal to the processing circuit, which responds by causing the client network circuit to reverse the power-down sequence and return to the active mode to service the client request. In this manner, errors can be prevented because the client requests received during a power-down sequence of the client network circuit are not lost.

### TECHNICAL FIELD

The technology of the disclosure relates generally to power-saving modes in processor-based systems, such as a system-on-a-chip (SOC), that includes a network(s) servicing client device(s) and, more particularly, to the network(s) entering into a low-power mode in response to inactivity in its serviced client devices.

### BACKGROUND

Processor-based systems commonly include a processing circuit(s) (e.g., a central processing unit (CPU)) that executes instructions according to an application to perform computing operations for performing tasks. Such processor-based systems may be provided in an integrated circuit (IC), such as a system-on-a-chip (SOC), resident with other client devices (e.g., memory, peripheral devices, communications interfaces) that are utilized by the processing circuit to perform tasks. The processing circuits and client devices may be general processing circuits or specialized circuits designed for handling specialized tasks. To provide managed access between the processing circuit(s) and the client devices, a network(s) (e.g., a network-on-chip (NOC) in the case of an SOC), may be provided in the processor-based system to manage requests from the processing circuit(s) to the client devices, and vice versa. The network may also facilitate communication between different client devices coupled to the network. A processor-based system may be organized into multiple groupings of client devices that are each coupled to their own respective network to facilitate distributed communications between the processing circuit(s) and the client devices.

Power savings is an important aspect in many electronic devices, particularly those that are battery powered, such as hand-held devices and extended reality headsets. To extend battery life, each of the client devices in a processing system may power themselves down to a low-power consumption mode (“low-power mode”) when not performing an application task(s). When all of the client devices coupled to a particular network are inactive or in a low-power mode, the network itself may also power down or enter into a low-power mode. However, powering down or entering a low-power mode in the network may involve a sequence of steps to transition from an operational mode to a low-power mode. During such a sequence, the network may be unable to respond to any new tasks assigned to one of the client processing circuits on the network, thereby potentially causing an unrecoverable error.

### SUMMARY

Aspects disclosed herein include interrupting a network power-down sequence in a processor-based system to service a client request. Related methods of interrupting power-down sequences in a processing system are also disclosed. A processor-based system in a system-on-chip (SOC) includes a client network-on-chip (NOC) over which a processing circuit communicates with one or more client device(s) in a client subsystem to carry out tasks performed as a result of executing computer instructions for an application. During a period of inactivity in the client device(s), the client NOC may enter a low-power mode by initiating a power-down sequence. The client NOC is configured to receive client requests from the client device(s) in the event a client device in the client subsystem becomes active during the power-down sequence. The client subsystem provides an interrupt signal to the processing circuit, which responds by causing the client NOC to reverse the power-down sequence and return to the active mode to service the client request. In this manner, errors can be prevented because the client requests received during a power-down sequence of the client NOC are not lost. In some examples, the client NOC may reverse the power-down sequence from any stage in the power-down sequence.

In this regard, in one aspect, an SOC comprising a processor-based system is disclosed. The SOC includes a processing circuit configured to execute instructions of an application and a first client NOC coupled to the processing circuit. The SOC also includes a first client device coupled to the first client NOC and configured to execute a task for the application, wherein the first client NOC is configured to initiate a power-down sequence to transition from an active mode to a low-power mode, provide a first interrupt signal to the processing circuit in response to receiving a first client request from the first client device to the first client NOC during the power-down sequence, and reverse the power-down sequence to transition back to the active mode in response to a first wakeup signal from the processing circuit.

In another aspect, a method of interrupting a power-down sequence in a client NOC in a processing system in a SOC is disclosed. The method includes executing instructions of an application in a processing circuit and initiating, in a first client NOC, a power-down sequence to transition from an active mode to a low-power mode. The method also includes receiving, in the first client NOC, a first client request from a first client device during the power-down sequence; providing a first interrupt signal to the processing circuit in response to receiving the first client request during the power-down sequence; and reversing the power-down sequence of the first client NOC to transition back to the active mode in response to a first wakeup signal from the processing circuit.

In another aspect, an integrated circuit (IC) in an integrated circuit is disclosed. The IC includes a processing circuit, a first client NOC coupled to the processing circuit, and a first client device coupled to the first client NOC. The first client NOC is configured to initiate a power-down sequence to transition from an active mode to a low-power mode; provide a first interrupt signal to the processing circuit in response to receiving a first client request from the first client device during the power-down sequence; and reverse the power-down sequence to transition back to the active mode in response to a first wakeup signal from the processing circuit.

### BRIEF DESCRIPTION OF THE DRAWINGS

FIG. 1 is a schematic diagram of an exemplary processing system in an integrated circuit (IC), including a client network-on-chip (NOC) in which a power-down sequence may be reversed to avoid a failure to respond to a client request;

FIG. 2 is a diagram of the stages of a power-down sequence and a power-up sequence of a client NOC in transitions between an active mode and a low-power mode;

FIG. 3 is a flowchart illustrating an exemplary method of reversing a power-down sequence of the client NOC of FIG. 1 to avoid a failure to respond to a client request;

FIG. 4 is a schematic diagram of a first example of a processing system in an IC with multiple client NOCs that may reverse a power-down sequence to avoid a failure to respond to a client request;

FIG. 5 is a schematic diagram of a second example of a processing system in an IC with multiple client NOCs that may reverse a power-down sequence to avoid a failure to respond to a client request;

FIG. 6 is a block diagram of an exemplary wireless communications device that includes an IC, including a client NOC in which a power-down sequence may be reversed to avoid a failure to respond to a client request; and

FIG. 7 is a block diagram of an exemplary processor-based system that includes radio-frequency (RF) components that can be disposed on ICs, including a client NOC in which a power-down sequence may be reversed to avoid a failure to respond to a client request.

### DETAILED DESCRIPTION

With reference now to the drawing figures, several exemplary aspects of the present disclosure are described. The word “exemplary” is used herein to mean “serving as an example, instance, or illustration. ” Any aspect described herein as “exemplary” is not necessarily to be construed as preferred or advantageous over other aspects.

Aspects disclosed herein include interrupting a network power-down sequence in a processor-based system to service a client request. Related methods of interrupting power-down sequences in a processing system are also disclosed. A processor-based system in a system-on-chip (SOC) includes a client network-on-chip (NOC) over which a processing circuit communicates with one or more client device(s) in a client subsystem to carry out tasks performed as a result of executing computer instructions for an application. During a period of inactivity in the client device(s), the client NOC may enter a low-power mode by initiating a power-down sequence. The client NOC is configured to receive client requests from the client device(s) in the event a client device in the client subsystem becomes active during the power-down sequence. The client subsystem provides an interrupt signal to the processing circuit, which responds by causing the client NOC to reverse the power-down sequence and return to the active mode to service the client request. In this manner, errors can be prevented because the client requests received during a power-down sequence of the client NOC are not lost. In some examples, the client NOC may reverse the power-down sequence from any stage in the power-down sequence.

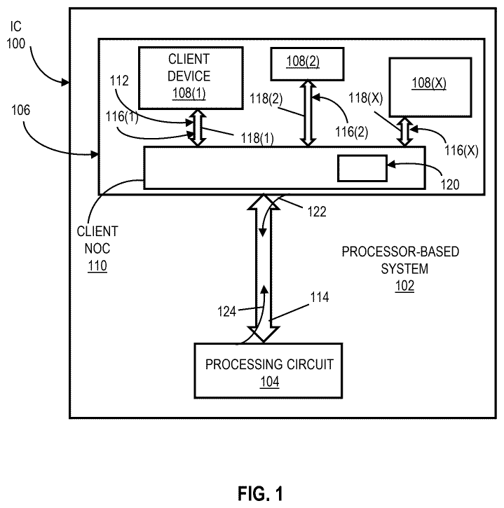

FIG. 1 is a schematic diagram of an exemplary integrated circuit (IC) 100, including a processor-based system 102 having a processing circuit 104 coupled to a first client subsystem 106. The client subsystem 106 includes client devices 108(1)-108(X) coupled to a client network-on-chip (NOC) 110. A power-down sequence of the client NOC 110 may be reversed after it has been initiated to avoid a failure to respond to a client request 112 from one of the client devices 108(1)-108(X), requesting access to the client NOC 110.

During operation, the client devices 108(1)-108(X) execute tasks under control of the processing circuit 104 according to computer instructions of an application executed in the processing circuit 104. The processing circuit 104 sends tasks (e.g., commands or requests for data) to the client NOC 110 on a network interface 114, and the client NOC 110 forwards the tasks to the respective client devices 108(1)-108(X). The client devices 108(1)-108(X) are coupled to the client NOC 110 and may include processing devices, multi-media devices, memory devices, etc. The client NOC 110 transfers data between the client devices 108(1)-108(X) and the processing circuit 104 while the client NOC 110 is in an active mode. The client NOC 110 may also provide low latency communications between the client devices 108(1)-108(X), which are each configured to perform tasks in response to applications executed in the processing circuit 104.

The client NOC 110 receives indications 116(1)-116(X) from the client devices 108(1)-108(X) of activity or inactivity. The indications 116(1)-116(X) and the client request 112 may be transferred from the client devices 108(1)-108(X) on respective device interfaces 118(1)-118(X). The client request 112 is shown in FIG. 1 on the device interface 118(1) but the client request 112 may be received from any of the client devices 108(1)-108(X). The client NOC 110 may receive the client request 112 when one of the client devices 108(1)-108(X) needs to perform a transaction over the client NOC 110. Based on the indications 116(1)-116(X), the first client NOC 110 may determine that the client devices 108(1)-108(X) are inactive. In some examples, one or more of the client devices 108(1)-108(X) may enter a low-power mode when they are inactive to conserve power, which is of particular importance in battery-powered devices, for example. Since a purpose of the client NOC 110 is to provide communications to and/or among the client devices 108(1)-108(X), when all the client devices 108(1)-108(X) are inactive, the client NOC 110 is also inactive. However, in an idle or inactive mode, the client NOC 110 still consumes power. To further reduce power consumption when the client NOC 110 is inactive, the client NOC 110 may enter a low-power mode after a power-down process. In contrast to an idle or inactive mode, in which internal logic circuits of the client NOC 110 are still active, the client NOC 110 may consume less power in a low-power mode because one or both of a clock signal CLK and a power signal PWR provided to the client NOC 110 is turned off.

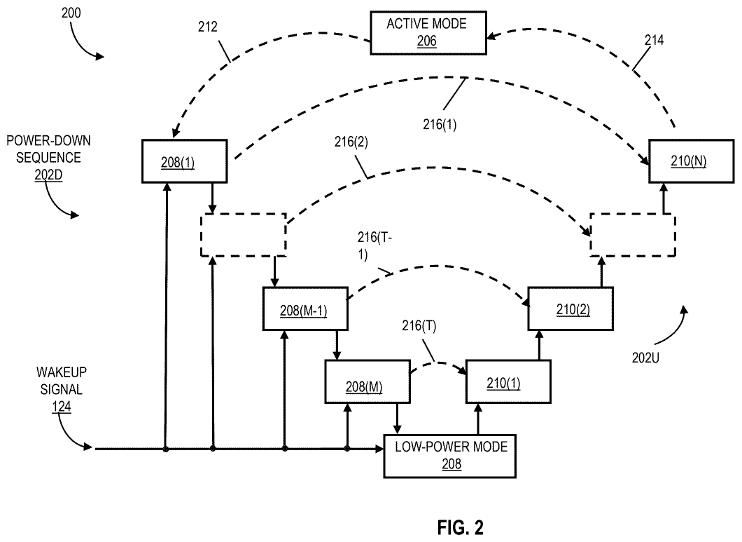

The client NOC 110 may include storage circuits 120, which may include configuration registers or memory circuits in which operational data (e.g., programmable information) of the client NOC 110 may be stored, and which would be lost in a low-power mode. To avoid the loss of operational data, one of the steps in the power-down sequence, after the client NOC 110 initiates or enters the low-power mode, is to transfer or save the operational data from the client NOC 110 to another data storage circuit or memory in the processor-based system 102, where the operational data will not be lost when the client NOC 110 enters the low-power mode. The power-down sequence is discussed in more detail with reference to FIG. 2, below.

The client NOC 110 may initiate the power-down sequence in response to the indications 116(1)-116(X) being in a state that indicates all of the client devices 108(1)-108(X) are inactive. Initiating the power-down sequence may include the client NOC 110 sending a request (not shown) to the processing circuit 104. Alternatively, the client NOC 110 may enter the low-power mode without informing the processing circuit 104.

In some situations, even though the indications 116(1)-116(X) indicate that all of the client devices 108(1)-108(X) are inactive, one or more of the client devices 108(1)-108(X) may be triggered to perform another task or to complete a previously started task. In some examples, one of the client devices 108(1)-108(X) may be triggered by the processing circuit 104 or by an external (e.g., user) input. In such circumstances, after the client NOC 110 has initiated the power-down sequence, the client NOC 110 may receive the client request 112 for access to the client NOC 110 from any one of the client devices 108(1)-108(X).

Conventionally, once the client NOC 110 initiates a power-down sequence, the power-down sequence will proceed to the low-power mode without interruption, even if a client request is received. Once in the low-power mode, the client NOC 110 can be returned to an active mode by a signal from the processing circuit. However, in the exemplary processor-based system 102, in response to receiving the client request 112 from any of the client devices 108(1)-108(X), the client NOC 110 may reverse the power-down sequence and transition back to the active mode to service the client request 112.

In more detail, the client subsystem 106 may provide (e.g., generate and send) an interrupt signal 122 to the processing circuit 104 on the network interface 114, for example, indicating that the client NOC 110 is in the power-down sequence and the client request 112 has been received. In response to the interrupt signal 122, the processing circuit 104 may provide (e.g., generate and send) a wakeup signal 124 to the client NOC 110. The client NOC 110 is configured to, in response to the wakeup signal 124, reverse the power-down sequence and transition back to the active mode. In particular, in response to receiving the wakeup signal 124 during any stage or step of the power-down sequence, the client NOC 110 may reverse the power-down sequence and transition back to the active mode.

FIG. 2 is a diagram 200 of a power-down sequence 202D and a power-up sequence 202U of the client NOC 110 in FIG. 1, illustrating transitions between an active mode 206 and a low-power mode 208. Features of the processor-based system 102 in FIG. 1 are also referred to in the following description. In the example in FIG. 2, the power-down sequence 202D includes downward stages 204(1)-204(M), and the power-up sequence 202U includes upward stages 210(1)-210(N). Although the number M of the downward stages 204(1)-204(M) and the number N of the upward stages 210(1)-210(N) appear to be the same in FIG. 2, the power-down sequence 202D and the power-up sequence 202U are not limited in this regard and may have different numbers of respective stages.

The power-down sequence 202D of the client NOC 110 may be initiated from the active mode 206 on the condition that the indications 116(1)-116(X) indicate that the client devices 108(1)-108(X) are inactive. With no activity in the client devices 108(1)-108(X), the client NOC 110 may also be idle or inactive. Thus, in response to the indications 116(1)-116(X) that the client devices 108(1)-108(X) are either already in a low-power mode or they are inactive and may transition into a low-power mode due to inactivity, the client NOC 110 may initiate the power-down sequence 202D. The power-down sequence 202D includes steps to transition the client NOC 110 to the low-power mode 208.

As noted above, when the client NOC 110 is inactive, having no instructions or data to process or being stopped from processing any such instructions or data, the client NOC 110 is still receiving the clock signal CLK in an active (oscillating) state and the power signal PWR is providing power or current. Thus, in the active mode and the inactive mode, the clock signal CLK and the power signal PWR are both “turned on”. In contrast, in “low-power mode”, one or both of the clock signal CLK and the power signal PWR provided to the processing circuit 104 is turned off to reduce power consumption. In some examples, the clock signal CLK may be turned off during the power-down sequence 202D before the power signal PWR is turned off.

While turning off the clock signal CLK alone may stop state changes in any logic circuits in the client NOC 110, leakage currents in the logic circuits continue to allow some power consumption as long as the power signal PWR is turned on. In some examples, the power signal PWR may be turned off without necessarily turning off the clock signal CLK, but in such examples, the clock signal CLK will not cause any power consumption in the logic circuits. When the power signal PWR is turned off, the power signal PWR is not supplying power (e.g., current) to the client NOC 110, and no power is consumed.

The downward stages 204(1)-204(M) may refer to conditions, steps, stages, and/or corresponding periods of time in which certain actions are performed or in which the client NOC 110 waits for an indication of completion of a request (e.g., in another circuit) or that a condition has been satisfied. Each of the downward stages 204(1)-204(M) is provided to prepare the client NOC 110 to gracefully enter the low-power mode 208 and to subsequently return to the active mode 206 in a known state.

For example, the client NOC 110 may make a transition 212 from the active mode 206 to the downward stage 204(1) in response to receiving the indications 116(1)-116(X) which signify that the client devices 108(1)-108(X) are inactive. The downward stage 204(1) of the power-down sequence 202D may include saving or storing operational data, such as configuration information and/or programming data of the client NOC 110 to a non-volatile memory or a memory or storage circuit to which the power signal PWR will not be turned off while the client NOC 110 is in the low-power mode. Thus, the operational data can be preserved and restored to the client NOC 110 in the power-up sequence 202U. The downward stage 204(M-1) may include sending a request to a clock control circuit to turn off the clock signal CLK provided to the client NOC 110 and waiting for the clock signal CLK to be turned off (e.g., to stop oscillating) before moving to downward stage 204(M). The downward stage 204(M) may include sending a request to a power control circuit to turn off the power signal PWR and waiting for the power signal PWR to be turned off, putting the clock network circuit into the low-power mode 208. The power-down sequence 202D may include additional stages not shown in FIG. 2 occurring at any point between the active mode 206 and the low-power mode 208, such as between downward stages 204(1) and 204(M-1), for example.

The power signal PWR to the client NOC 110 may be individually turned off while leaving the power signal PWR to the processing circuit 104 turned on and in an active state. While the client NOC 110 remains in the low-power mode 208, an external circuit, such as the processing circuit 104, can trigger the client NOC 110 to begin the power-up sequence 202U which includes entering the upward stage 210(1) to return to the active mode 206.

The upward stage 210(1) may include turning on the power signal PWR to the client NOC 110. The upward stage 210(2) may include sending a request to turn on the clock signal CLK. The upward stage 210(N) may include restoring the configuration information and/or data to the client NOC 110 prior to transitioning 214 back to the active mode 206. The power-up sequence 202U may include additional stages not shown in FIG. 2 occurring at any point between the low-power mode 208 and the active mode 206, such as between upward stages 210(2) and 210(N), or before the upward stage 210(1), for example.

Initiating the power-down sequence 202D in the client NOC 110 may include the transition 212 from the active mode 206 to the downward stage 204(1), and progressing sequentially through the downward stages 204(1)-204(M) to the low-power mode 208 in response to the indications 116(1)-116(X) from the client devices 108(1)-108(X). In addition, in an exemplary aspect, the client NOC 110 may alternatively reverse the power-down sequence 202D and transition back to the active mode 206 from any of the downward stages 204(1)-204(M). As discussed above and shown in FIG. 1, any one of the client devices 108(1)-108(X) coupled to the client NOC 110 may be triggered (e.g., by a signal from the processing circuit 104 or a signal provided from outside the processor-based system 102) to resume activity while the client NOC 110 is in the power-down sequence 202D (e.g., in one of the downward stages 204(1)-204(M)). In this situation, one of the client devices 108(1)-108(X) sends the client request 112 to the client NOC 110. In response to the client request 112 during the power-down sequence 202D, the client NOC 110 provides the interrupt signal 122 to the processing circuit 104, and the processing circuit 104 provides the wakeup signal 124 to the client NOC 110. In response to the wakeup signal 124, the client NOC 110 may reverse the power-down sequence 202D. In this regard, the client NOC 110 is configured to make any of the transitions 216(1)-216(T) from any one of the downward stages 204(1)-204(M) to one of the upward stages 210(1)-210(N).

Depending on the downward stage 204(1)-204(M) of the power-down sequence 202D that the client NOC 110 is in when the wakeup signal 124 is received, the client NOC 110 may take an appropriate one of the transitions 216(1)-216(T) to one of the upward stages 210(1)-210(N). It should be understood that reversing the power-down sequence 202D from a particular one of the downward stages 204(1)-204(M) to return to the active mode 206 may require a different number of upward stages 210(1)-210(N) than the downward stages 204(1)-204(M) reached in the power-down sequence 202D when the wakeup signal 124 is received. For example, receiving the wakeup signal 124 at downward stage 204(M-1) and reversing the power-down sequence 202D to return to the active mode 206 may not involve M-1 of the upward stages 210(1)-210(N). The transitions 216(1)-216(T) may be from any one of the downward stages 204(1)-204(M) to any appropriate upward stage 210(1)-210(N). After taking one of the transitions 216(1)-216(T) to one of the upward stages 210(1)-210(N), the client NOC 110 may continue the normal progression of the power-up sequence 202U back to the active mode 206, in which the client NOC 110 can service the client request 112. Consequently, the client request 112 is not lost and an error in the processor-based system 102 may be avoided.

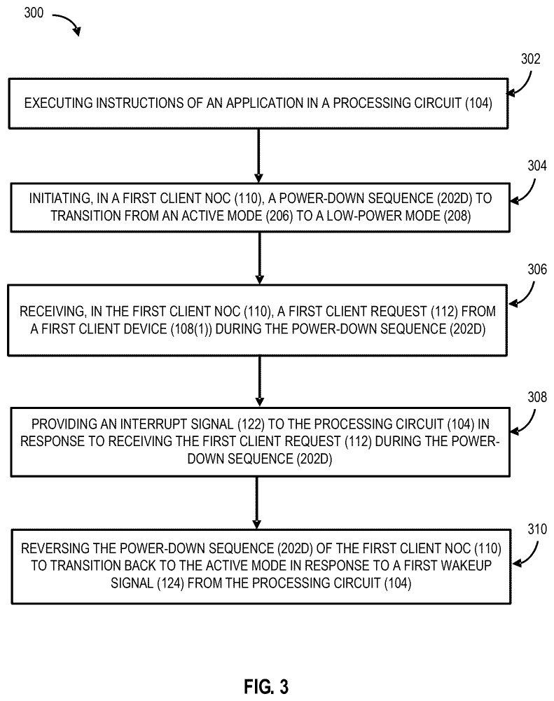

FIG. 3 is a flowchart illustrating an exemplary method 300 of reversing a power-down sequence 202D of the first client NOC 110 to avoid a failure to respond to a client request 112. The method 300 includes executing instructions of an application in a processing circuit 104 (block 302) and initiating, in a first client NOC 110, a power-down sequence 202D to transition from an active mode 206 to a low-power mode 208 (block 304). The method 300 further includes receiving, in the first client NOC 110, a first client request 112 from a first client device 108(1) during the power-down sequence (block 306), providing an interrupt signal 122 to the processing circuit 104 in response to receiving the first client request 112 during the power-down sequence 202D (block 308) and reversing the power-down sequence 202D of the first client NOC 110 to transition back to the active mode 206 in response to a first wakeup signal 124 from the processing circuit 104 (block 310).

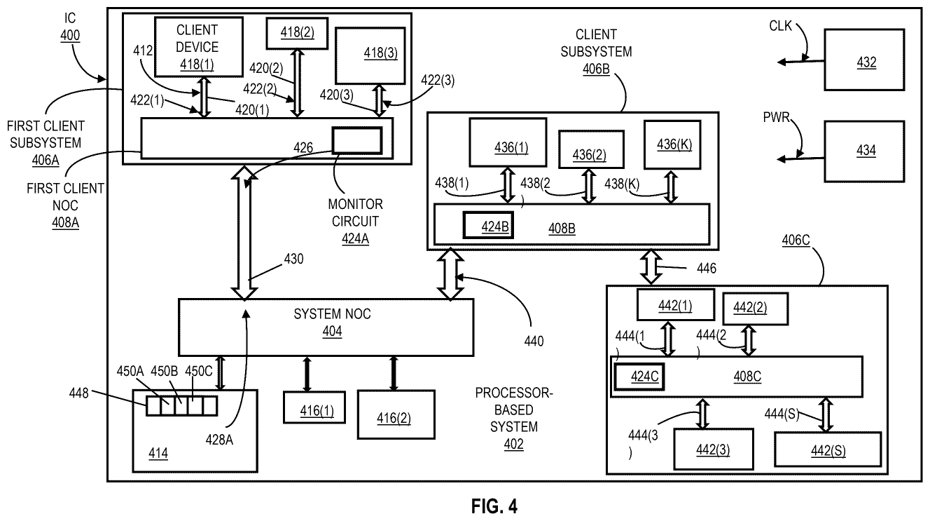

FIG. 4 is a schematic diagram of another exemplary IC 400 in which a processor-based system 402 includes a system NOC 404 coupled to client subsystems 406A, 406B, and 406C that include client NOCs 408A, 408B, and 408C, respectively, which are configured to initiate a power-down sequence, corresponding to the power-down sequence 202D in FIG. 2, in response to indications of inactivity from their respective client devices and reverse the power-down sequence in response to a client request 412. Each of the client NOCs 408A, 408B, and 408C may correspond in this regard to the description of the client NOC 110 in FIG. 1.

The system NOC 404 includes a processing circuit 414 and system devices 416(1) and 416(2), wherein the number (2) of system devices 416(1), 416(2) is merely exemplary as the system NOC 404 may include any number of system devices. Similarly, the system NOC 404 may be coupled to any number of other client subsystems in addition to the client subsystems 406A, 406B, and 406C.

The client subsystem 406A, for example, includes client devices 418(1)-418(J) (where J=3 in this example) coupled to the first client NOC 408A on client interfaces 420(1)-420(J). Each of the client devices 418(1)-418(3) may execute tasks of an application under control of the processing circuit 414 or another one of the system devices 416(1), 416(2). The client devices 418(1)-418(3) provide indications 422(1)-422(3) of activity or inactivity from which the first client NOC 408A may determine whether to initiate the power-down sequence 410. As discussed with regard to the processor-based system 102 in FIG. 1, the first client NOC 408A may initiate the power-down sequence 410 (not shown) in response to the indications 422(1)-422(3) and reverse the power-down sequence 410 in response to the client request 412 from any of the client devices 418(1)-418(3). The power-down sequence 410 may be the power-down sequence 202D in FIG. 2.

The first client subsystem 406A may include a first monitor circuit 424A that remains active while the first client NOC 408A proceeds through the power-down sequence 410 and sends an interrupt signal 426 to the processing circuit 414 if the client request 412 is received from any of the client devices 418(1)-418(3) during the power-down sequence 410. The processing circuit 414 may respond to the interrupt signal 426 by providing a first wakeup signal 428A that causes the first client NOC 408A to reverse the power-down sequence and return to the active mode. The first monitor circuit 424A may cause the first client NOC 408A to reverse the power-down sequence 410. The first monitor circuit 424A may be internal or external to the first client NOC 408A. Communication of the interrupt signal 426 and the first wakeup signal 428A may occur on a network interface 430 between the system NOC 404 and the first client subsystem 406A or by way of other signals (not shown) because the first client NOC 408A has initiated the power-down sequence 410.

In the power-down sequence 410, the first client NOC 408A may store operational data in a client device of one of the client subsystems 406B and 406C, or in one of the system devices 416(1), 416(2). For example, one of the client subsystems 406B and 406C may always become active before the first client subsystem 406A and may enter a low-power mode after the first client NOC 408A enters the low-power mode. Thus, the first client NOC 408A may be able to store operational data in client devices of the client subsystems 406B and 406C before entering the low-power mode and retrieve such operational data during a power-up sequence. In another example, the system NOC 404 may not enter a low-power mode that would cause a loss of data, so the operational data of the first client NOC 408A may be safely stored in one of the system devices 416(1), 416(2) during the low-power mode of the first client subsystem 406A.

Entering the low-power mode may include sending a request to a clock control circuit 432 to turn off the clock signal CLK provided to the first client NOC 408A and sending a request to a power control circuit 434 to turn off the power signal PWR provided to the first client subsystem 406A.

The second client subsystem 406B includes client devices 436(1)-436(K), where N=3 in this example, coupled to the second client NOC 408B by client interfaces 438(1)-438(K) and the second client NOC 408B is coupled to the system NOC 404 by a network interface 440. The third client subsystem 406C includes client devices 442(1)-442(S), where M=4 in this example. The client devices 442(1)-442(S) are coupled to the third client NOC 408C by client interfaces 444(1)-444(S). The third client NOC 408C is not coupled directly to the system NOC 404 in this example. Instead, the third client NOC 408C is coupled to the second client NOC 408B by way of a network interface 446. The numbers N and M may be any appropriate positive integer number. The client subsystems 406B and 406C include monitor circuits 424B and 424C, respectively, to monitor the client requests 412 and send interrupt signals 426 to the processing circuit 414.

The processing circuit 414 in FIG. 4 may correspond to the processing circuit 104 in FIG. 1. In addition, the processing circuit 414 may include an interrupt register 448 that includes storage elements 450A, 450B, 450C, etc. that are set by the interrupt signals 426 from each of the client subsystems 406A, 406B, and 406C. In this manner, the processing circuit 414 can determine whether to send the first wakeup signal 428A to the first client subsystem 406A, send a second wakeup signal 428B to the second client subsystem 406B, and/or send a third wakeup signal 428C to the third client subsystem 406C. Upon providing any of the wakeup signals 428A, 428B, and 428C, the processing circuit 414 may reset the storage elements 450A, 450B, and 450C independently.

It should be understood that each of the client NOCs 408A, 408B, 408C may perform the same power-down sequence 202D and power-up sequence 202U as shown in FIG. 2. In addition, the storage elements 450A, 450B, and 450C are controlled (e.g., set and reset) independently. Thus, initiation and reversal of the power-down sequences 202D in any of the client NOCs 408A, 408B, and 408D may occur independently, except as otherwise controlled by the processing circuit 414 or another system device.

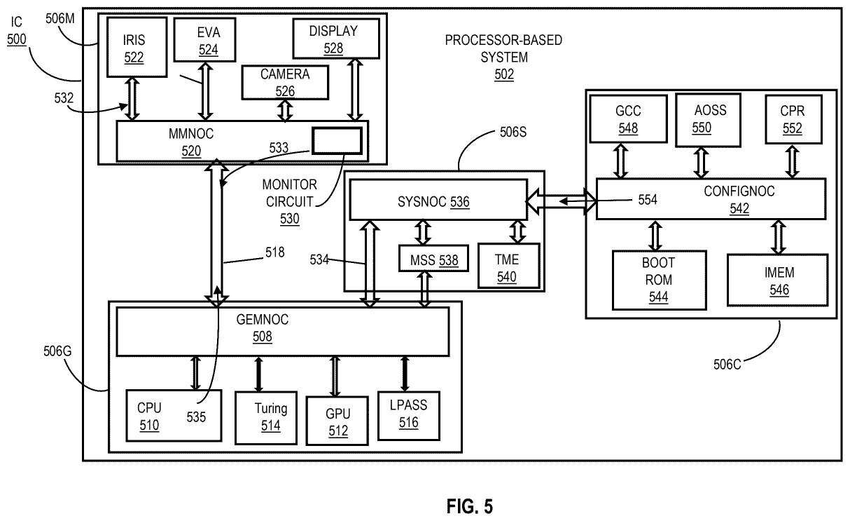

FIG. 5 is a schematic diagram of another exemplary IC 500 in which a processor-based system 502 includes a graphics subsystem 506G coupled to a multi-media subsystem 506M, a system management subsystem 506S, and a configuration subsystem 506C, collectively referred to herein as “subsystems 506”. The graphics subsystem 506G includes a graphics NOC (GEMNOC) 508 coupled to a plurality of devices including a central processing unit (CPU) 510, a graphics processing unit (GPU) 512, a graphics processing circuit (TURING) 514, and a low power and audio subsystem (LPASS) 516. The GEMNOC 508 may be the system NOC 404 in FIG. 4 and the CPU 510 may be the processing circuit 414.

The graphics subsystem 506G is coupled to the multi-media subsystem 506M by way of a network interface 518 that is coupled to a multi-media NOC (MMNOC) 520 in the multi-media subsystem 506M. The MMNOC 520 is also coupled to a multi-media processing device (IRIS) 522, an engine for video analytics (EVA) 524, a camera 526, and a display 528. The multi-media subsystem 506M includes a monitor circuit 530 to monitor any client request 532 that may be sent to the MMNOC 520 by the IRIS 522, EVA 524, camera 526, and/or display 528 while the MMNOC 520 is in a power-down sequence, as described above, to enter a low-power mode. The MMNOC 520 may initiate the power-down sequence in response to indications that the IRIS 522, EVA 524, camera 526, and display 528 are inactive. The monitor circuit 530 may be internal or external to the MMNOC 520. The monitor circuit 530 may send an interrupt signal 533 to inform the CPU 510 to wake up the MMNOC 520 and, in response, the CPU 510 may generate a wakeup signal 535 to cause the MMNOC 520 to reverse the power-down sequence and return to the active mode to handle the client request 532.

The graphics subsystem 506G is coupled to the system management subsystem 506S by way of a network interface 534, which is coupled between the GEMNOC 508 and a system NOC (SYSNOC) 536 in the system management subsystem 506S. The graphics subsystem 506G and the system management subsystem 506S are also indirectly coupled through a modem subsystem (MSS) 538. The system management subsystem 506S also includes a trust management engine (TME) 540 to handle security in the IC 500.

The system management subsystem 506S is also coupled to the configuration subsystem 506C and, therefore, provides a path for communication between the configuration subsystem 506C and the GEMNOC 508 or the MMNOC 520. The configuration subsystem 506C includes a configuration NOC (CONFIGNOC) 542 coupled to a boot read-only memory (BOOTROM) 544, an internal memory (IMEM) 546, a global clock controller (GCC) 548, a power management subsystem (AOSS) 550, and a droop detection circuit (CPR) 552. The CONFIGNOC 542 may determine that all of the BOOTROM 544, IMEM 546, GCC 548, AOSS 550, and CPR 552 are inactive and initiate a power-down sequence, such as the power-down sequence 202D in FIG. 2. The configuration subsystem 506C is configured to monitor the BOOTROM 544, IMEM 546, GCC 548, AOSS 550, and CPR 552 for a client request 532 to the CONFIGNOC 542 while the CONFIGNOC 542 is in the power-down sequence. The configuration subsystem 506C is also configured to, in response to detecting the client request 532 during the power-down sequence of the CONFIGNOC 542, generate an interrupt signal 554 that is provided to the CPU 510 and reverse the power-down sequence in response to a wakeup signal (not shown).

Returning to the system management subsystem 506S, the SYSNOC 536 may also enter a low-power mode. However, because the SYSNOC 536 provides a path for communication between the CONFIGNOC 542 and the GEMNOC 508, the SYSNOC 536 may need to receive an indication that the CONFIGNOC 542, in addition to the TME 540 and MSS 538, is inactive before initiating the power-down sequence.

The system management subsystem 506S and the configuration subsystem 506C may include monitor circuits similar to the monitor circuit 530 to monitor client requests 532 while the CONFIGNOC 542 and the SYSNOC 536 are in their respective power-down sequences and provide interrupt signals to the CPU 510 to wake up the CONFIGNOC 542 and/or the SYSNOC 536 to service the client requests 532.

Integrated circuits (ICs) in which a processor-based system may avoid errors caused by losing track of client requests in a client NOC during a power-down sequence by reversing the power-down sequence may be employed in processor-based devices. Examples of such processor-based devices, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, laptop computer, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, and a vehicle component.

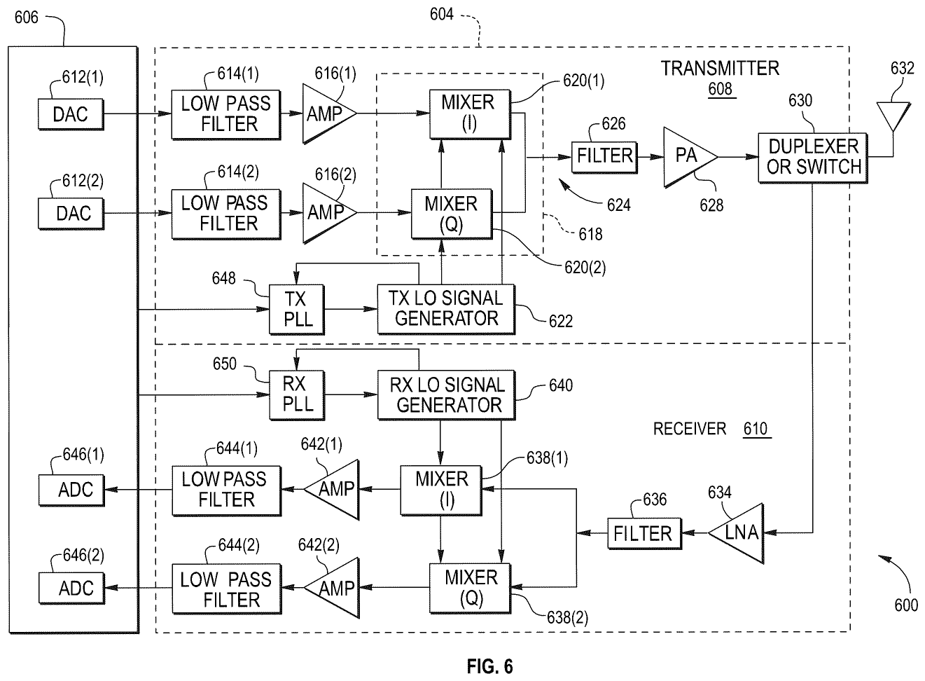

FIG. 6 illustrates an exemplary wireless communications device 600 that includes radio-frequency (RF) components formed from one or more ICs 602, wherein any of the ICs 602 may include a processing system in which a client NOC reverses a power-down sequence to avoid a failure to respond to a client request from a client device, as shown in FIG. 1. The wireless communications device 600 may include or be provided in any of the above-referenced devices as examples. As shown in FIG. 6, the wireless communications device 600 includes a transceiver 604 and a data processor 606. The data processor 606 may include a memory to store data and program codes. The transceiver 604 includes a transmitter 608 and a receiver 610 that support bi-directional communications. In general, the wireless communications device 600 may include any number of transmitters 608 and/or receivers 610 for any number of communication systems and frequency bands. All or a portion of the transceiver 604 may be implemented on one or more analog ICs, RF ICs (RFICs), mixed-signal ICs, etc.

The transmitter 608 or the receiver 610 may be implemented with a super-heterodyne architecture or a direct-conversion architecture. In the super-heterodyne architecture, a signal is frequency-converted between RF and baseband in multiple stages, for example, from RF to an intermediate frequency (IF) in one stage and then from IF to baseband in another stage for the receiver 610. In the direct-conversion architecture, a signal is frequency-converted between RF and baseband in one stage. The super-heterodyne and direct-conversion architectures may use different circuit blocks and/or have different requirements. In the wireless communications device 600 in FIG. 6, the transmitter 608 and the receiver 610 are implemented with the direct-conversion architecture.

In the transmit path, the data processor 606 processes data to be transmitted and provides I and Q analog output signals to the transmitter 608. In the exemplary wireless communications device 600, the data processor 606 includes digital-to-analog converters (DACs) 612(1), 612(2) for converting digital signals generated by the data processor 606 into the I and Q analog output signals (e.g., I and Q output currents) for further processing.

Within the transmitter 608, lowpass filters 614(1), 614(2) filter the I and Q analog output signals, respectively, to remove undesired signals caused by the prior digital-to-analog conversion. Amplifiers (AMPs) 616(1), 616(2) amplify the signals from the lowpass filters 614(1), 614(2), respectively, and provide I and Q baseband signals. An upconverter 618 upconverts the I and Q baseband signals with I and Q transmit (TX) local oscillator (LO) signals through mixers 620(1), 620(2) from a TX LO signal generator 622 to provide an upconverted signal 624. A filter 626 filters the upconverted signal 624 to remove undesired signals caused by the frequency up-conversion as well as noise in a receive frequency band. A power amplifier (PA) 628 amplifies the upconverted signal 624 from the filter 626 to obtain the desired output power level and provides a transmit RF signal. The transmit RF signal is routed through a duplexer or switch 630 and transmitted via an antenna 632.

In the receive path, the antenna 632 receives signals transmitted by base stations and provides a received RF signal, which is routed through the duplexer or switch 630 and provided to a low noise amplifier (LNA) 634. The duplexer or switch 630 is designed to operate with a specific receive (RX)-to-TX duplexer frequency separation, such that RX signals are isolated from TX signals. The received RF signal is amplified by the LNA 634 and filtered by a filter 636 to obtain a desired RF input signal. Down-conversion mixers 638(1), 638(2) mix the output of the filter 636 with I and Q RX LO signals (i.e., LO_I and LO_Q) from an RX LO signal generator 640 to generate I and Q baseband signals. The I and Q baseband signals are amplified by AMPs 642(1), 642(2) and further filtered by lowpass filters 644(1), 644(2) to obtain I and Q analog input signals, which are provided to the data processor 606. In this example, the data processor 606 includes analog-to-digital converters (ADCs) 646(1), 646(2) for converting the analog input signals into digital signals to be further processed by the data processor 606.

In the wireless communications device 600 of FIG. 6, the TX LO signal generator 622 generates the I and Q TX LO signals used for frequency up-conversion, while the RX LO signal generator 640 generates the I and Q RX LO signals used for frequency down-conversion. Each LO signal is a periodic signal with a particular fundamental frequency. A TX phase-locked loop (PLL) circuit 648 receives timing information from the data processor 606 and generates a control signal used to adjust the frequency and/or phase of the TX LO signals from the TX LO signal generator 622. Similarly, an RX PLL circuit 650 receives timing information from the data processor 606 and generates a control signal used to adjust the frequency and/or phase of the RX LO signals from the RX LO signal generator 640.

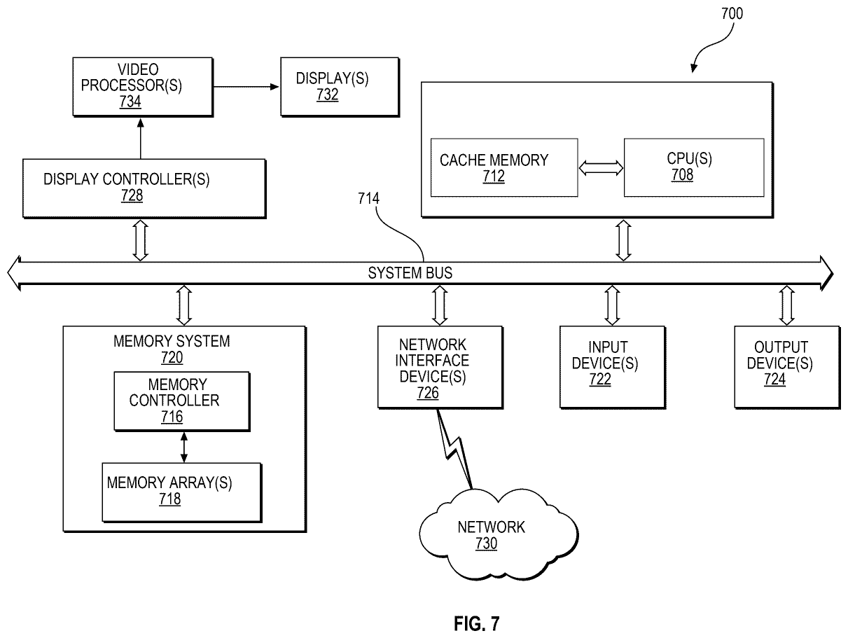

In this regard, FIG. 7 illustrates an example of a processor-based system 700 that can include a processing system in which a client NOC reverses a power-down sequence to avoid a failure to respond to a client request from a client device, as shown in FIG. 1. The processor-based system 700 includes a central processing unit (CPU) 708. The CPU 708 may have cache memory 712 coupled to the CPU 708 for rapid access to temporarily stored data. The CPU 708 is coupled to a system bus 714 and can intercouple master and slave devices included in the processor-based system 700. As is well known, the CPU 708 communicates with these other devices by exchanging address, control, and data information over the system bus 714. For example, the CPU 708 can communicate bus transaction requests to a memory controller 716, as an example of a slave device. Although not illustrated in FIG. 7, multiple system buses 714 could be provided, wherein each system bus 714 constitutes a different fabric.

Other master and slave devices can be connected to the system bus 714. As illustrated in FIG. 7, these devices can include a memory system 720 that includes the memory controller 716 and a memory array(s) 718, one or more input devices 722, one or more output devices 724, one or more network interface devices 726, and one or more display controllers 728, as examples. The input device(s) 722 can include any type of input device, including, but not limited to, input keys, switches, voice processors, etc. The output device(s) 724 can include any type of output device, including, but not limited to, audio, video, other visual indicators, etc. The network interface device(s) 726 can be any device configured to allow an exchange of data to and from a network 730. The network 730 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 726 can be configured to support any type of communications protocol desired.

The CPU 708 may also be configured to access the display controller(s) 728 over the system bus 714 to control information sent to one or more displays 732. The display controller(s) 728 sends information to the display(s) 732 to be displayed via one or more video processor(s) 734, which processes the information to be displayed into a format suitable for the display(s) 732. The display(s) 732 can include any type of display, including, but not limited to, a cathode ray tube (CRT), a liquid crystal display (LCD), a plasma display, a light emitting diode (LED) display, etc.

Those of skill in the art will further appreciate that the various illustrative logical blocks, modules, circuits, and algorithms described in connection with the aspects disclosed herein may be implemented as electronic hardware, instructions stored in memory or in another computer-readable medium wherein any such instructions are executed by a processor or other processing device, or combinations of both. The devices and components described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from and write information to the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

Implementation examples are described in the following numbered clauses:
1. A system-on-chip (SOC) comprising a processor-based system comprising:
   a processing circuit configured to execute instructions of an application;
   a first client network-on-chip (NOC) coupled to the processing circuit; and
   a first client device coupled to the first client NOC and configured to execute a task of the application;
   wherein the first client NOC is configured to:
      initiate a power-down sequence to transition from an active mode to a low-power mode;
      provide a first interrupt signal to the processing circuit in response to receiving a first client request from the first client device to the first client NOC during the power-down sequence; and
      reverse the power-down sequence to transition back to the active mode in response to a first wakeup signal from the processing circuit.
2. The SOC of clause 1, further comprising a plurality of client devices comprising the first client device, wherein:
   each client device of the plurality of client devices is configured to provide, to the first client NOC, an indication of inactivity in the client device; and
   the first client NOC is configured to initiate the power-down sequence in response to the indication of inactivity from each of the plurality of client devices.
3. The SOC of clause 2, wherein:
   the first client NOC is further configured to transfer data between the plurality of client devices and the processing circuit in the active mode; and
   at least one of a power signal to the first client NOC and a clock signal to the first client NOC is turned off in the low-power mode to reduce power consumption in the first client NOC.
4. The SOC of any of clause 1 to clause 3, wherein:
   the power-down sequence of the first client NOC comprises a plurality of stages; and
   the first client NOC is configured to reverse the power-down sequence in response to receiving the first wakeup signal in any of the plurality of stages of the power-down sequence.
   the first client NOC is configured to reverse the power-down sequence in response to receiving the first wakeup signal in any of the stages of the power-down sequence.
5. The SOC of any of clause 2 to clause 4, further comprising:
   a second client NOC; and
   a first network interface coupled between the first client NOC and the second client NOC;
   wherein:
      the processing circuit is coupled to the second client NOC; and
      the processing circuit is configured to send instructions to the plurality of client devices on the first network interface.
6. The SOC of clause 5, further comprising:
   a second network interface coupled between the first client NOC and the second client NOC; wherein:
   the first client NOC provides the first interrupt signal to the processing circuit on the second network interface.
7. The SOC of clause 5 or clause 6, further comprising:
   a third client NOC coupled to the second client NOC; and
   a plurality of second client devices coupled to the third client NOC;
   wherein the third client NOC is configured to:
      provide a second interrupt signal to the processing circuit in response to a second client request from one of the plurality of second client devices to the third client NOC during a power-down sequence of the third client NOC; and
      reverse the power-down sequence and transition back to the active mode in response to a second wakeup signal from the processing circuit.
8. The SOC of clause 7, wherein the processing circuit is further configured to:
   provide the first wakeup signal in response to the first interrupt signal; and
   provide the second wakeup signal in response to the second interrupt signal.
9. The SOC of clause 8, further comprising:
   a first monitor circuit coupled to the first client NOC and configured to monitor the first client request to the first client NOC and provide the first interrupt signal; and
   a second monitor circuit coupled to the second client NOC and configured to monitor the second client request to the second client NOC and provide generate the second interrupt signal.
10. The SOC of any of clause 1 to clause 9, further comprising:
   a clock control circuit configured to generate a first clock signal to the first client NOC; and
   a power control circuit configured to generate a first power signal to the first client NOC,
   wherein the first client NOC is configured to initiate the power-down sequence to turn off the first clock signal and the first power signal.
11 . The SOC of clause 1 integrated into a device selected from the group consisting of: a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component;.
12 . A method of interrupting a power-down sequence in a client network-on-chip (NOC) in a processing system in a system-on-chip (SOC), the method comprising:
   executing instructions of an application in a processing circuit;
   initiating, in a first client NOC, a power-down sequence to transition from an active mode to a low-power mode;
   receiving, in the first client NOC, a first client request from a first client device during the power-down sequence;
   providing a first interrupt signal to the processing circuit in response to receiving the first client request during the power-down sequence; and
   reversing the power-down sequence of the first client NOC to transition back to the active mode in response to a first wakeup signal from the processing circuit.
13. The method of clause 12, further comprising:
   providing, to the first client NOC, an indication of inactivity from each client device of a plurality of client devices comprising the first client device; and
   initiating, in the first client NOC, the power-down sequence in response to the indication of inactivity from each of the plurality of client devices.
14. The method of clause 13, further comprising:
   transferring data on the first client NOC between the plurality of client devices and the processing circuit in the active mode; and
   turning off at least one of a power signal to the first client NOC and a clock signal to the first client NOC to enter an inactive mode to reduce power consumption.
15. The method of any of clause 12 to clause 14, wherein:
   in response to receiving the first wakeup signal in the first client NOC in any of a plurality of stages of the power-down sequence, reversing a transition to the low-power mode.
16. The method of any of clause 12 to clause 15, further comprising:
   sending instructions from the processing circuit to the plurality of client devices on the first client NOC through a first network interface, wherein the first network interface is coupled between the first client NOC and a second client NOC coupled to the processing circuit.
17. The method of clause 16, further comprising:
   providing the first interrupt signal to the processing circuit on a second network interface coupled between the first client NOC and the second client NOC.
18. The method of any of clause 12 to clause 17, further comprising:
   providing, in a third client NOC comprising a plurality of second client devices, a second interrupt signal to the processing circuit in response to a second client request from one of the plurality of second client devices to the third client NOC during a power-down sequence of the third client NOC; and
   reversing, by the third client NOC, the power-down sequence in response to a second wakeup signal from the processing circuit.
19. The method of clause 18, further comprising:
   provide the first wakeup signal in response to the first interrupt signal; and providing the second wakeup signal in response to the second interrupt signal.
20. A processing system in an integrated circuit (IC), comprising:
   a processing circuit;
   a first client network-on-chip (NOC) coupled to the processing circuit; and
   a first client device coupled to the first client NOC;
   wherein the first client NOC is configured to:
      initiate a power-down sequence to transition from an active mode to a low-power mode;
      provide a first interrupt signal to the processing circuit in response to receiving a first client request from the first client device during the power-down sequence; and
      reverse the power-down sequence to transition back to the active mode in response to a first wakeup signal from the processing circuit.

What is claimed is:

1. A system-on-chip (SOC) comprising a processor-based system comprising:
a processing circuit configured to execute instructions of an application;
a first client network-on-chip (NOC) coupled to the processing circuit; and
a first client device coupled to the first client NOC and configured to execute a task for the application;
wherein the first client NOC is configured to:
initiate a power-down sequence to transition from an active mode to a low-power mode;
provide a first interrupt signal to the processing circuit in response to receiving a first client request from the first client device to the first client NOC during the power-down sequence; and
reverse the power-down sequence to transition back to the active mode in response to a first wakeup signal from the processing circuit.

2. The SOC of claim 1, further comprising a plurality of client devices comprising the first client device, wherein:
each client device of the plurality of client devices is configured to provide, to the first client NOC, an indication of inactivity in the client device; and
the first client NOC is configured to initiate the power-down sequence in response to the indications of inactivity from each of the plurality of client devices.

3. The SOC of claim 2, wherein:
the first client NOC is further configured to transfer data between the plurality of client devices and the processing circuit in the active mode; and
at least one of a power signal to the first client NOC and a clock signal to the first client NOC is turned off in the low-power mode to reduce power consumption in the first client NOC.

4. The SOC of claim 1, wherein:
the power-down sequence of the first client NOC comprises a plurality of stages; and
the first client NOC is configured to reverse the power-down sequence in response to receiving the first wakeup signal in any of the plurality of stages of the power-down sequence.

5. The SOC of claim 2, further comprising:
a second client NOC; and
a first network interface coupled between the first client NOC and the second client NOC;
wherein:
the processing circuit is coupled to the second client NOC; and
the processing circuit is configured to send instructions to the plurality of client devices on the first network interface.

6. The SOC of claim 5, further comprising:
a second network interface coupled between the first client NOC and the second client NOC; wherein:
the first client NOC provides the first interrupt signal to the processing circuit on the second network interface.

7. The SOC of claim 5, further comprising:
a third client NOC coupled to the second client NOC; and
a plurality of second client devices coupled to the third client NOC;
wherein the third client NOC is configured to:
provide a second interrupt signal to the processing circuit in response to a second client request from one of the plurality of second client devices to the third client NOC during a power-down sequence of the third client NOC; and
reverse the power-down sequence and transition back to the active mode in response to a second wakeup signal from the processing circuit.

8. The SOC of claim 7, wherein the processing circuit is further configured to:
provide the first wakeup signal in response to the first interrupt signal; and
provide the second wakeup signal in response to the second interrupt signal.

9. The SOC of claim 8, further comprising:
a first monitor circuit coupled to the first client NOC and configured to monitor the first client request to the first client NOC and provide the first interrupt signal; and
a second monitor circuit coupled to the second client NOC and configured to monitor the second client request to the second client NOC and provide the second interrupt signal.

10. The SOC of claim 1, further comprising:
a clock control circuit configured to generate a first clock signal to the first client NOC; and
a power control circuit configured to generate a first power signal to the first client NOC;
wherein the first client NOC is configured to initiate the power-down sequence to turn off the first clock signal and the first power signal.

11. The SOC of claim 1 integrated into a device selected from the group consisting of:
a set-top box; an entertainment unit; a navigation device; a communications device; a fixed location data unit; a mobile location data unit; a global positioning system (GPS) device; a mobile phone; a cellular phone; a smartphone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; and a vehicle component;.

12. A method of interrupting a power-down sequence in a client network-on-chip (NOC) in a processing system in a system-on-chip (SOC), the method comprising:
executing instructions of an application in a processing circuit;
initiating, in a first client NOC, a power-down sequence to transition from an active mode to a low-power mode;
receiving, in the first client NOC, a first client request from a first client device to the first client NOC during the power-down sequence;
providing a first interrupt signal to the processing circuit in response to receiving the first client request during the power-down sequence; and
reversing the power-down sequence of the first client NOC to transition back to the active mode in response to a first wakeup signal from the processing circuit.

13. The method of claim 12, further comprising:
providing, to the first client NOC, an indication of inactivity from each client device of a plurality of client devices comprising the first client device; and
initiating, in the first client NOC, the power-down sequence in response to the indication of inactivity from each of the plurality of client devices.

14. The method of claim 13, further comprising:
transferring data on the first client NOC between the plurality of client devices and the processing circuit in the active mode; and
turning off at least one of a power signal to the first client NOC and a clock signal to the first client NOC to enter an inactive mode to reduce power consumption.

15. The method of claim 14, wherein:
in response to receiving the first wakeup signal in the first client NOC in any of a plurality of stages of the power-down sequence, reversing a transition to the low-power mode.

16. The method of claim 13, further comprising:
sending instructions from the processing circuit to the plurality of client devices on the first client NOC through a first network interface, wherein the first network interface is coupled between the first client NOC and a second client NOC coupled to the processing circuit.

17. The method of claim 16, further comprising:
providing the first interrupt signal to the processing circuit on a second network interface coupled between the first client NOC and the second client NOC.

18. The method of claim 12, further comprising:
providing, in a third client NOC comprising a plurality of second client devices, a second interrupt signal to the processing circuit in response to a second client request from one of the plurality of second client devices to the third client NOC during a power-down sequence of the third client NOC; and
reversing, by the third client NOC, the power-down sequence in response to a second wakeup signal from the processing circuit.

19. The method of claim 18, further comprising:
providing the first wakeup signal in response to the first interrupt signal; and
providing the second wakeup signal in response to the second interrupt signal.

20. A processing system in an integrated circuit (IC), comprising:
a processing circuit;
a first client network-on-chip (NOC) coupled to the processing circuit; and
a first client device coupled to the first client NOC;
wherein the first client NOC is configured to:
initiate a power-down sequence to transition from an active mode to a low-power mode;
provide a first interrupt signal to the processing circuit in response to receiving a first client request from the first client device during the power-down sequence; and
reverse the power-down sequence to transition back to the active mode in response to a first wakeup signal from the processing circuit.
